(19) United States
(12) Patent Application Publication
(10) Pub. No.: US 2006/0283033 A1
(43) Pub. Date: Dec. 21, 2006

(54) SAW GUIDE ATTACHMENT FOR A SPEED SQUARE

(76) Inventor: Clayton R. Peterson, Laguna Woods, CA (US)

Correspondence Address: QUICKPATENTS, INC., 31877 DEL OBISPO, SUITE 202, SAN JUAN CAPISTRANO, CA, 92675, US

(21) Appl. No.: 11/424,220

(22) Filed: Jun. 14, 2006

Related U.S. Application Data
(60) Provisional application No. 60/690,722, filed on Jun. 15, 2005.

(51) Int. Cl. B43L 7/00

(52) U.S. Cl. 33/429

(57) ABSTRACT

An attachment for a carpenter's speed square is disclosed. The attachment comprises a C-shaped channel for accepting in slidable engagement a flange of the speed square. An extension extends from a first side of the C-shaped channel generally parallel to an axis thereof and terminates at a distal end thereof. A plurality of thumb screws are included to fix the C-shaped channel rigidly to the speed square. In use, the attachment is slid onto the flange of the speed square and a saw is brought into contact with the speed square such that a base plate of the saw abuts a fence edge of the triangular base. The C-shaped channel is extended towards the saw until the distal end of the extension contacts a surface of a saw blade. The plurality of thumb screws are then tightened. As such, the distal end of the extension extends a distance d away from the fence edge, the distance d corresponding to the distance between the surface of the saw blade and a fence contacting edge of the saw base plate. The speed square is then positioned along the workpiece until the distal end of the extension is aligned with a desired cutting point on the workpiece. The speed square is held fixed against the workpiece so that the base plate of the saw may be abutted against the fence edge and the saw may be used to cut the workpiece along the desired cut mark. The saw base plate is free to clear the extension as the extension lies below the surface of the workpiece upon which the saw base plate rests.

### CROSS-REFERENCE TO RELATED APPLICATIONS

This application claims the benefit of U.S. Provisional Patent Application 60/690,722, Filed on Jun. 15, 2005.

### STATEMENT REGARDING FEDERALLY SPONSORED RESEARCH AND DEVELOPMENT

Not Applicable.

### FIELD OF THE INVENTION

This invention relates to tools, and more particularly to a saw guide for attaching to a carpenter's speed square.

### BACKGROUND

In carpentry it is often necessary to make many cuts using a portable circular saw, such as while making cuts in an attic of a new building structure. While the circular saw is easy enough to use, the exact positioning of the blade while cutting a workpiece is often difficult to gauge accurately. This is due in part to the fact that a base plate of the saw which rests against the workpiece while the saw is used does not facilitate accurate placement of the blade while cutting.

It is well known that a carpenter's speed square, such as that disclosed in U.S. Pat. No. 6,688,014 to Allemand on Feb. 10, 2004, or such as that disclosed in U.S. Pat. No. 5,170,568 to Wright on Dec. 15, 1992, facilitates the proper marking of an orthogonal cutting line on a workpiece, such as a 2×4 wood stud. It is also known to use such a speed square as a saw base plate fence for guiding a circular saw to cut orthogonally with respect to the side of a workpiece. However, using a speed square in such a manner requires mentally calculating the distance of the desired cut and subtracting the distance between the saw blade and the edge of the saw's base plate. Such a practice slows the user down considerably, particularly when a large number of cuts are required and particularly when the distance between the edge of the base plate of the saw and the saw blade is not an even or easy to manipulate number, such as 1 and ⅞ths inches.

Therefore, there is a need for an inexpensive attachment for standard speed squares that provides an easy way to guide the user as to the proper positioning for the speed square to act as a fence or saw guide, while not requiring any mathematical calculations, double measuring, or other time consuming activity. Such a needed device would be relatively inexpensive to manufacture and easy to use on existing speed squares. The present invention accomplishes these objectives.

### SUMMARY OF THE INVENTION

The present device is an attachment for a carpenter's speed square that includes a right-triangular base and a flange. The base includes a fence edge at a right angle to the flange.

The attachment of the present invention comprises a C-shaped channel for accepting in slidable engagement the flange of the speed square. An extension extends from a first side of the C-shaped channel generally parallel to an axis thereof. The extension is an extension of that portion of the C-shaped channel that extends away from a distal side of the triangular base. The extension terminates at a distal end thereof Likewise, a second extension extends from a second side of the C-shaped channel, the second extension being a mirror image of the first extension about a center point of the C-shaped channel. The second extension is generally utilized by left-handed users, while the first extension is generally for use by right-handed users.

A plurality of thumb screws are included in a bottom surface of the C-shaped channel, the thumb screws oriented generally orthogonally to the bottom surface and the axis of the C-shaped channel. Each thumb screw may be tightened so that it engages the flange of the speed square, thereby fixing the C-shaped channel rigidly to the speed square.

In use the attachment is slid onto the flange of the speed square. A saw, such as a conventional circular saw, is brought into contact with the speed square such that a base plate of the saw abuts the fence edge of the triangular base in generally co-planar alignment. Then the C-shaped channel is extended towards the saw until the distal end of the extension contacts a surface of a saw blade of the saw. At this point the plurality of thumb screws are tightened so that the C-shaped channel and extension are rigidly fixed to the flange of the speed square. As such, the distal end of the extension extends a distance d away from the fence edge, the distance d corresponding to the distance between the surface of the saw blade and a fence contacting edge of the saw base plate.

Once the thumb screws are tightened and the distance d is established, the speed square is placed against the workpiece such that the triangular base rests against the workpiece. The speed square and the attachment are slid along the workpiece until the distal end of the extension is aligned with a desired cut mark on the workpiece. The speed square is held fixed against the workpiece so that the base plate of the saw may be abutted against the fence edge and the saw may be used to cut the workpiece along the desired cut mark. The saw base plate is free to clear the extension because the extension lies below the surface of the workpiece upon which the saw base plate rests.

As such, the present invention accomplishes the goal of facilitating the proper cutting of workpieces with a circular saw without the need to perform any math calculations or double measurements. The present invention is relatively simple to manufacture and use, and can be used with existing speed squares and a variety of currently used circular and other saws. Further, present invention may be used by both left and right-handed users, as well as on either the left or right side of the saw. Moreover, the present invention is easy to attach and remove from the speed square as desired. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a C-shaped channel of an attachment of the present invention engaged to a flange of a carpenter's speed square;

FIG. 2 is an exploded view of the invention;

FIG. 3 is a left-side elevation view of the invention, illustrating the C-shaped channel of an attachment of the present invention engaged to the flange of the carpenter's speed square;

FIG. 4 is an exploded left-elevational view of the invention, illustrating in more detail the C-shaped channel and a thumb screw for rigidly holding the attachment to the speed square;

FIG. 5 is a perspective view of the invention in use, illustrating the flange of the speed square pressed against a workpiece such that a fence edge of the triangular base acts as a guide for a base plate of a saw;

FIG. 6 is a perspective view of the invention in use, illustrating how the extension of the attachment is aligned with a desired cut mark on the workpiece such that the distance d corresponds to the distance between the edge of the base plate of the saw and a saw blade of the saw; and

FIG. 7 is a perspective view of the invention, illustrating how the base plate of the saw is guided by the fence edge of the speed square, such that the saw cuts the workpiece along the desired cut mark.

### DETAILED DESCRIPTION OF THE PREFERRED EMBODIMENT

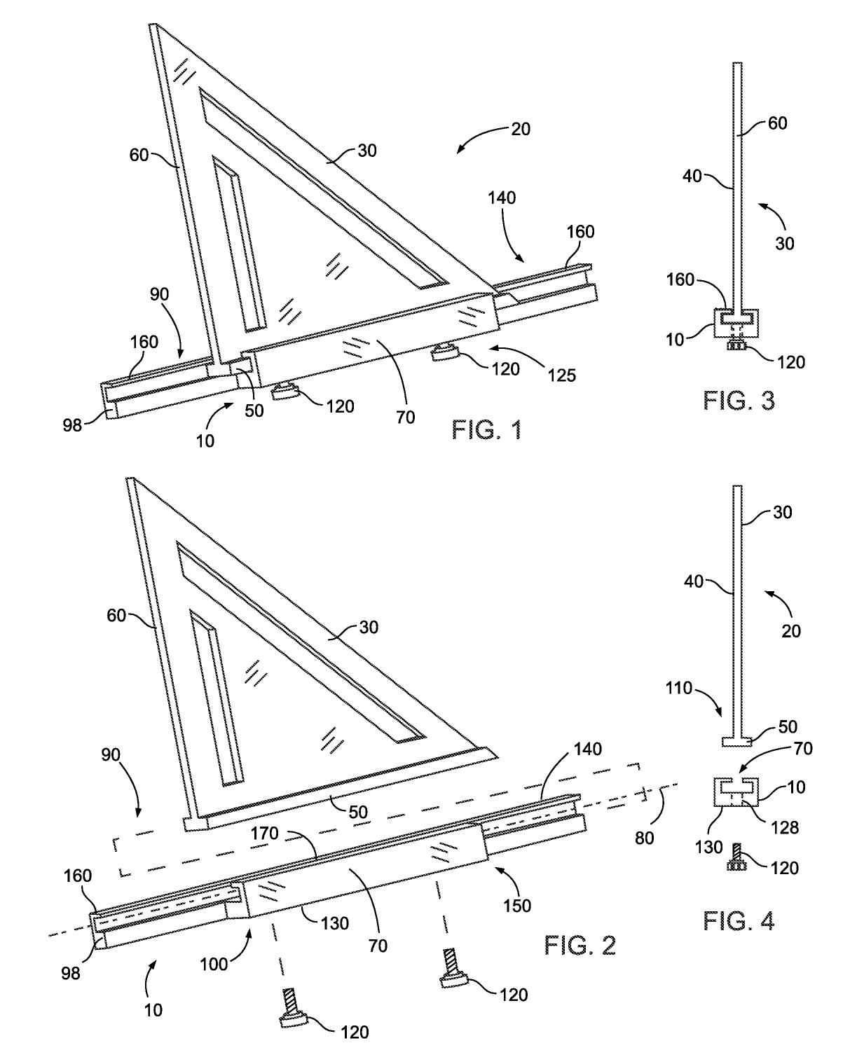

FIG. 1 illustrates an attachment 10 for a carpenter's speed square 20. Such a speed square 20 typically includes a right-triangular base 30 having a planar workpiece contacting surface 40 and a flange 50. The base 30 includes a fence edge 60 at a right angle to the flange 50.

The attachment 10 comprises a C-shaped channel 70 for accepting in slidable engagement the flange 50 of the speed square 20. The outside shape of the C-shaped channel is generally a rectangular parallelepiped, such that its surfaces remain either parallel or orthogonal to the fence edge 60 of the speed square 20 regardless of the positioning of the C-shaped channel 70 along the flange 50 (FIG. 3). The C-shaped channel is further defined by a first side 100 and a second side 150 (FIG. 2). The C-shaped channel 70 defines an axis 80 thereof, and is formed from an suitably rigid plastic or polymer material. The C-shaped channel 70 can be advantageously be either injection molded or extruded and then machined. Speed squares in the prior art are made of various rigid materials, and the present invention may be easily manufactured of the same materials if sold together with a speed square of the prior art.

An extension 90 extends from the first side 100 of the C-shaped channel 70 generally parallel to the axis 80. The extension 90 is an extension of that portion of the C-shaped channel 70 that extends away from a distal side 110 of the workpiece contacting surface 40 (FIG. 4). The extension 90 terminates at a distal end 98 (FIG. 2).

Likewise, an extension 140 extends from a second side 150 of the C-shaped channel 70 generally parallel to the axis 80 (FIG. 2). The extension 140 is an extension of that portion of the C-shaped channel 70 that extends away from the distal side 110 of the workpiece contacting surface 40 (FIGS. 4).

The attachment 10 includes an attachment means 125, which preferably includes at least one thumb screw 120 extending through a threaded aperture 128 of a bottom surface 130 of the C-shaped channel, each thumb screw 120 oriented generally orthogonally to the bottom surface 130 and the axis 80 of the C-shaped channel. Each thumb screw 120 may be tightened so that it engages the flange 50 of the speed square 20, thereby fixing the C-shaped channel rigidly to the speed square 20. Preferably, two thumb screws 120 are included (FIG. 2).

The extensions 90 and 140 each preferably include an abrasive surface 160 on a workpiece contacting side 170 thereof for providing a gripping force to a workpiece 180 when each extension is in contact therewith (FIG. 1). Such an abrasive surface 160 may be a plurality of ridges, a sandpaper-like texture, a high-friction rubber coating, or the like.

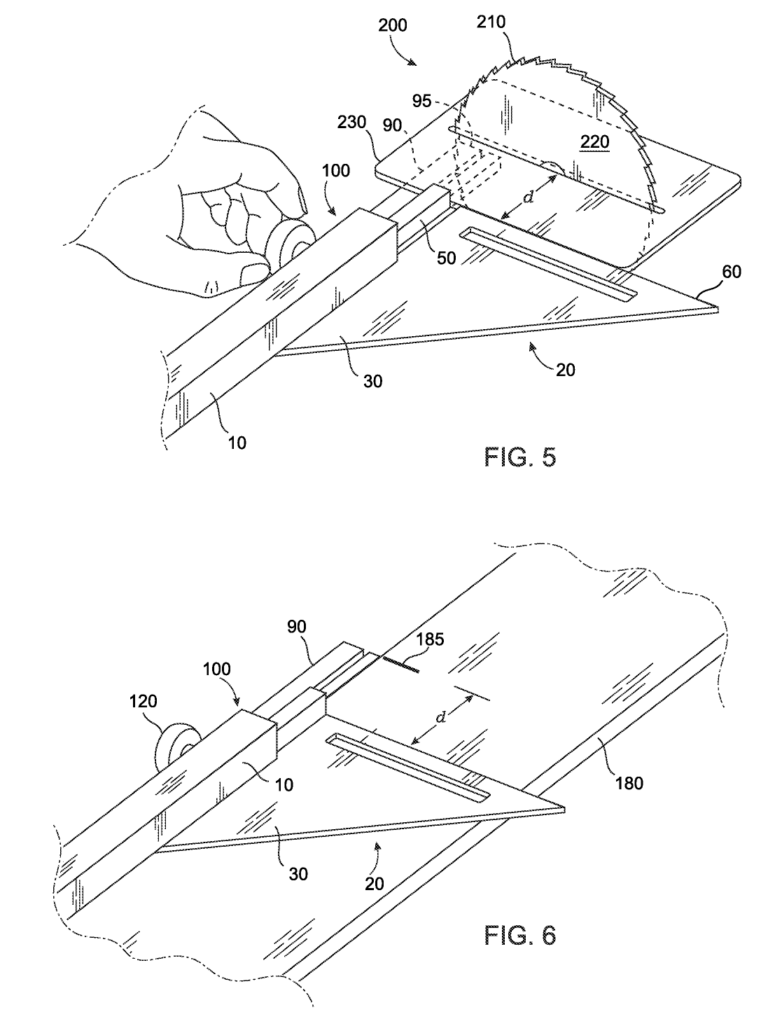

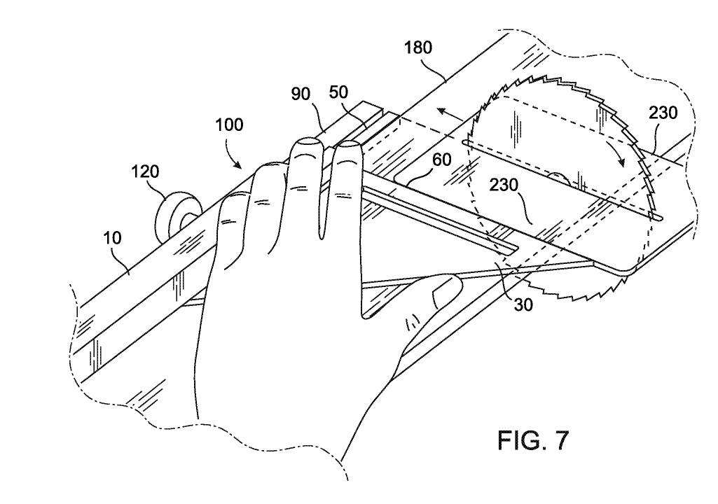

Referring now to FIG. 5, in use the attachment 10 is slid onto the flange 50 of the speed square 20. A saw 200, such as a conventional circular saw, is brought into contact with the speed square 20 such that a base plate 230 of the saw abuts the fence edge 60 of the triangular base 50 in generally co-planar alignment. Then the C-shaped channel is extended towards the saw 200 until the distal end 98 of the extension 90 contacts a surface 220 of a saw blade 210 of the saw. At this point the plurality of thumb screws 120 are tightened so that the C-shaped channel 70 and extension 90 are rigidly fixed to the flange 50 of the speed square 20. As such, the distal end 98 of the extension 90 extends a distance d away from the fence edge 60, the distance d corresponding to the distance between the surface 220 of the saw blade 210 and a fence contacting edge 235 of the saw base plate 230 (FIG. 7).

FIG. 7 illustrates that once the thumb screws 120 are tightened and the distance d is established, the speed square 20 is placed against the workpiece 180 such that the workpiece contact surface 40 of the triangular base 30 rests against the workpiece 180. The speed square 20 and the attachment 10 are slid along the workpiece 180 until the distal end 98 of the extension 90 is aligned with a desired cut mark 185 in the workpiece 180 (FIG. 6).

Referring now to FIG. 7, the speed square 20 is held fixed against the workpiece 180 so that the base plate 230 of the saw 200 may be abutted against the fence edge 60 and the saw 200 may be used to cut the workpiece 180. The saw blade 210 cuts along the desired cut mark 185, and the saw base plate 230 is free to clear the extension 90 because the extension 90 lies below the surface of the workpiece 180. The extension 90 is formed longer than the distance d prescribed by the most common circular saws in the marketplace so that the base plates 230 of each brand of saw may clear the extension 90 and not contact the C-shaped channel 70. For left-handed users use a saw 200 configured for left-handed use, the speed square 20 is flipped over with respect to the attachment 10, and an analogous procedure is followed.

While a particular form of the invention has been illustrated and described, it will be apparent that various modifications can be made without departing from the spirit and scope of the invention. For example, the length of the extensions 90 in relation to the length of the C-shaped channel 70 may vary. Likewise, the materials used to make the attachment 10 and thumbscrews 120 may be taken from any suitable material known in the art. Accordingly, it is not intended that the invention be limited, except as by the appended claims.

What is claimed is:

1. An attachment for a carpenter's speed square, the square defined by a right-triangular base having a workpiece contacting surface and a flange, the base further defined by a fence edge, the attachment comprising:
a C-shaped channel for accepting the flange of the speed square therein, the channel defining an axis;
a first extension extending from a first side of the channel substantially parallel to the axis of the channel and extending to a distal side of the workpiece contacting surface of the base.

2. The attachment of claim 1 wherein the C-shaped channel includes an attachment means to rigidly fix the channel in a substantially parallel alignment to the flange.

3. The attachment of claim 2 wherein the attachment means includes at least one thumb screw extending through a bottom of the C-shaped channel and contacting the flange of the speed square, such that each thumb screw may be tightened to rigidly fix the channel in a substantially parallel alignment to the flange.

4. The attachment of claim 1 wherein a second extension extends from a second side of the channel substantially parallel to the axis of the channel and extending to a distal side of the workpiece contacting surface of the base, whereby left-handed users and right-handed users can use the same attachment.

5. The attachment of claim 1 wherein the extension includes an abrasive surface on a workpiece contacting side thereof for providing a gripping force to a workpiece when the extension is in contact therewith.
